(19) United States
(12) Patent Application Publication
(10) Pub. No.: US 2024/0310747 A1
(43) Pub. Date: Sep. 19, 2024

(54) CYAN TONER AND TWO COMPONENT DEVELOPER

(71) Applicant: SHARP KABUSHIKI KAISHA, Osaka (JP)

(72) Inventors: YORITAKA TSUBAKI, Osaka (JP); Osamu Wada, Osaka (JP)

(21) Appl. No.: 18/592,752

(22) Filed: Mar. 1, 2024

(30) Foreign Application Priority Data
Mar. 14, 2023 (JP) 2023-039838

(51) Int. Cl. G03G 9/09; G03G 9/08; G03G 9/087; G03G 9/097

(52) U.S. Cl. CPC G03G 9/0908; G03G 9/0819; G03G 9/08711; G03G 9/09725; G03G 9/09733

(57) ABSTRACT

The above problem is solved by a cyan toner including toner particles including at least a binder resin, a sublimable dye, and a mold release agent, in which the binder resin includes a styrene-acrylic resin, the sublimable dye includes C.I. Disperse Blue 56 at a ratio of 5% to 15% by mass in the toner particles, the mold release agent has a melting point equal to or higher than 70° C. and equal to or lower than a softening point Tm of the cyan toner, and transmittance at a wavelength of 430 nm measured using an ultraviolet-visible spectrophotometer is 30% or more.

### BACKGROUND OF THE INVENTION

### Field of the Invention

The present disclosure relates to a cyan toner and a two component developer including the cyan toner.

### Description of the Background Art

Electrophotographic dyeing methods for dyeing hydrophobic fibers typified by polyester fabric are roughly divided into (1) a direct method in which after directly applying a toner to a material to be dyed, the material to be dyed is dyed with a dye in the toner through heat treatment, and a resin, a mold release agent, and the like other than the dye are dissolved by alkali washing and then removed; and (2) a sublimation transfer method in which after applying a toner to an intermediate recording medium such as paper, a material to be dyed is superimposed on a surface of the intermediate recording medium to which the toner has been applied, followed by heat and pressurization treatment to sublimate a dye in the toner and transfer same to the material to be dyed.

Among these dyeing methods, the sublimation transfer method can dye fibers of the material to be dyed with the dye alone among multiple components constituting the toner from the intermediate recording medium, and components constituting the toner other than the dye do not attach to the material to be dyed (fabric to be dyed, fabric). For this reason, the sublimation transfer method is considered to be suited to dyeing for uses in which texture is seen as important like clothing items such as sports apparel and interior accessories such as seats and sofas, and is considered to have an advantage that a risk of developing a rash or eczema due to a constituent other than the dye for persons having sensitive skin can be reduced.

Disperse dyes and oil-soluble dyes which are suitable to dye hydrophobic fibers are used as a dye in a toner used for the sublimation transfer method, and an easily sublimating-type dye (sublimable dye) with excellent suitability for sublimation transfer to hydrophobic fibers through heat treatment is particularly used among them.

In addition, the sublimation transfer method is advantageous not only because the sublimation transfer method does not need steps for washing, drying, and the like, and the number of steps for dyeing is dramatically reduced, but also because a line for washing and drying, a washing water treatment facility, and the like, which are costly and require a large-scale space and a large amount of running energy, become unnecessary.

Accordingly, the sublimation transfer method is considered as an excellent dyeing method capable of dyeing even a small-scale space.

On the other hand, ink-jet methods are mainly used as a method for dyeing fibers utilizing the sublimation transfer method in general. However, the sublimation transfer method in an ink-jet manner has, for example, the following problem: an organic solvent, which is one component constituting ink, volatilizes due to heat for transferring a dye to pollute a working environment. In contrast, the sublimation transfer method in an electrophotographic manner attracts attention, recently, since no volatile component is present in the toner thereof, not causing pollution of a working environment. A toner containing a polyester-based resin, a sublimable dye, at least one oil-soluble dye, and carnauba wax is suggested as a toner used in the sublimation transfer dying method in which dyeing is carried out in such an electrophotographic manner by attaching the toner to an intermediate recording medium (intermediate transfer medium), and sublimating a dye contained in the toner attached to the intermediate recording medium and transferring same to a material to be dyed, for example.

C.I. Disperse Blue 359 (D.B. 359) and C.I. Disperse Blue 360 (D.B. 360) are used as a cyan dye for an ink-jet printer using a sublimable blue dye currently on the market.

These cyan dyes are easily dispersed in a toner, in general. However, when these cyan dyes are included in a toner, a problem of causing the dye to bleed onto a surface when the toner is left at high temperature to deteriorate heat resistant preservability arises.

Therefore, use of C.I. Disperse Blue 56 (D.B. 56) as an alternative dye has been studied. C.I. Disperse Blue 56 exhibits good heat resistant preservability but is difficult to disperse in a toner and has low sublimation performance. Therefore, a problem of hardly obtaining sufficient image concentration when the dye is sublimated and transferred from an intermediate recording medium to a material to be dyed arises.

That is, when the dispersion state of the sublimable dye in a toner is poor, the following problem arises: there are many dye aggregates (dye crystalline bodies) with a large crystal diameter, the dye crystalline bodies dissociate from the toner and migrate from transfer paper to a material to be dyed during sublimation transfer, and image failure and deterioration of friction fastness are thus caused.

The present disclosure has thus been made in view of the above circumstances, and an object thereof is to provide: a cyan toner in which a dye is dispersed in a good dispersion state, a dye aggregate having a large crystal diameter is less present in the toner, a dye crystalline body is prevented from dissociating from the toner, and migration of a dye crystal to a material to be dyed during sublimation transfer from transfer paper to fabric can be suppressed; and a two component developer including the cyan toner and a carrier.

### SUMMARY OF THE INVENTION

As a result of intensive studies to solve the above problem, the present inventors have found that by finely dispersing a sublimable dye that includes C.I. Disperse Blue 56 at a certain ratio in a cyan toner, that is, by making transmittance at a wavelength of 430 nm measured using an ultraviolet-visible spectrophotometer 30% or more, an amount of a dye aggregate having a large crystal diameter present in the cyan toner is reduced, the dye aggregate is prevented from dissociating from the cyan toner, a dye crystal is prevented from migrating to fabric during transfer from transfer paper to the fabric, and image failure on the fabric and deterioration of friction fastness can be suppressed. The present inventors thus have completed the present disclosure.

The above described prior art does not disclose making transmittance at a wavelength of 430 nm measured using an ultraviolet-visible spectrophotometer 30% or more and does not disclose an effect provided thereby.

According to the present disclosure, provided is a cyan toner including toner particles including at least a binder resin, a sublimable dye, and a mold release agent, in which the binder resin includes a styrene-acrylic resin, the sublimable dye includes C.I. Disperse Blue 56 at a ratio of 5% to 15% by mass in the toner particles, the mold release agent has a melting point equal to or higher than 70° C. and equal to or lower than the softening point Tm of the cyan toner, and transmittance at a wavelength of 430 nm measured using an ultraviolet-visible spectrophotometer is 30% or more.

In addition, according to the present disclosure, provided is a two component developer including the above-described cyan toner and a carrier.

According to the present disclosure, a cyan toner in which a dye is dispersed in a good dispersion state, a dye aggregate having a large crystal diameter is less present in the toner, a dye crystalline body is prevented from dissociating from the toner, and migration of a dye crystal to a material to be dyed during sublimation transfer from transfer paper to fabric can be suppressed; and a two component developer including the cyan toner and a carrier can be provided.

### DESCRIPTION OF THE PREFERRED EMBODIMENTS

### (1) Cyan Toner

A cyan toner of the present disclosure includes toner particles including at least a binder resin, a sublimable dye, and a mold release agent, in which the binder resin includes a styrene-acrylic resin, the sublimable dye includes C.I. Disperse Blue 56 at a ratio of 5% to 15% by mass in the toner particles, the mold release agent has a melting point equal to or higher than 70° C. and equal to or lower than the softening point Tm of the cyan toner, and transmittance at a wavelength of 430 nm measured using an ultraviolet-visible spectrophotometer is 30% or more.

Although the definite reason why the cyan toner of the present disclosure provides the advantageous effects described above is not clear, the present inventors think that it is because interaction between dye molecules is changed by finely dispersing, in a compatible state, the sublimable dye with significantly weak van der Waals' force in the toner particles, and sublimation performance is changed consequently.

The “transmittance at a wavelength of 430 nm measured using an ultraviolet-visible spectrophotometer” is an index indicating the dispersion state of the sublimable dye in the toner particles. When the transmittance is less than 30%, the above-described advantageous effects of the cyan toner of the present disclosure are not provided. The transmittance is preferably 35% or more and more preferably 40% or more. The upper limit thereof is about 50%.

A measurement method for the transmittance will be described in the examples.

Hereinafter, (1) constituents of the cyan toner of the present disclosure, (2) a method for producing the cyan toner, and (3) a two component developer including the cyan toner of the present disclosure will be described.

### (1-1) Binder Resin

The binder resin included in the toner particles of the cyan toner of the present disclosure includes a styrene-acrylic resin (styrene-acrylic copolymer resin).

The styrene-acrylic resin can be produced by copolymerizing a styrene-based monomer and a (meth)acrylic monomer in a known method.

The “(meth)acrylic monomer” herein means an acrylic monomer and a methacrylic monomer.

The polymerization method includes bulk polymerization, solution polymerization, suspension polymerization, emulsion polymerization, and the like. The polymerization method is selected according to a molecular weight and physical properties of a resin to be obtained, and polymerization conditions may be set as appropriate.

Examples of the styrene-based monomer include styrene derivatives such as styrene, o-methylstyrene, m-methylstyrene, p-methylstyrene, α-methylstyrene, p-ethylstyrene, and 2,4-dimethylstyrene.

Examples of the acrylic monomer include acrylic acid and acrylic acid derivatives such as methyl acrylate, ethyl acrylate, n-butyl acrylate, isobutyl acrylate, propyl acrylate, octyl acrylate, 2-chloroethyl acrylate, and phenyl acrylate.

Examples of the methacrylic monomer include methacrylic acid and methacrylic acid derivatives such as methyl methacrylate, ethyl methacrylate, propyl methacrylate, n-butyl methacrylate, isobutyl methacrylate, n-octyl methacrylate, 2-ethylhexyl methacrylate, phenyl methacrylate, and dimethylamino methacrylate.

In the present disclosure, one kind of each of the above-described styrene-based monomer and the (meth)acrylic monomer may be used singly, or two or more thereof may be used in combination.

Examples of the styrene-acrylic resin include a combination of styrene and n-butyl acrylate described in Production Examples 1 and 2 in the examples.

The styrene-acrylic resin may include an additional monomer component within a range not impairing the effects of the cyan toner of the present disclosure.

Examples of the additional monomer component include maleic anhydride, monomethyl maleate, monoethyl maleate, monophenyl maleate, monoallyl maleate, and a vinyl monomer such as divinylbenzene.

The mass average molecular weight of the styrene-acrylic resin is preferably 5,000 to 500,000. When the mass average molecular weight is less than 5,000, heat resistance characteristics of the toner may deteriorate. On the other hand, when the mass average molecular weight exceeds 500,000, fixability to transfer paper may deteriorate.

The mass average molecular weight of the styrene-acrylic resin is more preferably 10,000 to 200,000.

The glass transition temperature Tg of the binder resin is preferably 50° C. to 70° C. When the glass transition temperature Tg is less than 50° C., heat resistant preservation stability the cyan toner may be poor. On the other hand, when the glass transition temperature Tg exceeds 70° C., low-temperature fixability to transfer paper is impaired, sublimation of the dye partially occurs at a time of attempting fixation to transfer paper at high temperature, and the image concentration may be poor when the dye is transferred from transfer paper to fabric.

The glass transition temperature Tg of the binder resin is more preferably 52° C. to 67° C. and still more preferably 55° C. to 65° C.

The softening point (softening temperature) Tm of the binder resin is preferably 100° C. to 150° C.

When the softening point Tm is less than 100° C., heat resistant preservation stability of the cyan toner may be poor. On the other hand, when the softening point Tm exceeds 150° C., low-temperature fixability to transfer paper is impaired, sublimation of the dye partially occurs at a time of attempting fixation to transfer paper at high temperature, and the image concentration may be poor when the dye is transferred from transfer paper to fabric.

The softening point Tm of the binder resin is more preferably 110° C. to 145° C. and still more preferably 120° C. to 140° C.

The content of the binder resin in the toner particles is not particularly limited and can be appropriately selected according to a purpose, and an indication thereof is usually 60% to 95% by mass based on the toner particles.

When the content of the binder resin in the toner particles is less than 60% by mass, viscoelastic characteristics required in fixation to transfer paper as a toner may not be obtained. On the other hand, the content of the binder resin in the toner particles exceeds 95% by mass, not only a dye concentration and mold release agent amount required but also an additive or the like for stabilizing charging characteristics is not enough, and performance of the present disclosure may not be fully provided.

The content of the binder resin is preferably 70% to 93% by mass and more preferably 80% to 90% by mass.

### (1-2) Sublimable Dye

The sublimable dye included in the toner particles of the cyan toner of the present disclosure includes C.I. Disperse Blue 56 at a ratio of 5% to 15% by mass based on the toner particles. Sublimation performance of C.I. Disperse Blue 56 alone as a sublimable dye is poor, and an image concentration enough for sublimation transfer to fabric cannot be ensured. However, dispersibility of C.I. Disperse Blue 56 in the toner particles is enhanced by the configuration of the cyan toner of the present disclosure, and a sufficient image concentration can be ensured. That is, the cyan toner of the present disclosure has good heat resistance and sublimation performance, ensures sufficient image concentration, and can form an image with high friction fastness on fabric.

When the content ratio of C.I. Disperse Blue 56 is 5% to 15% by mass based on the toner particles, dispersibility is enhanced, and sufficient image concentration can be ensured.

The content ratio of C.I. Disperse Blue 56 is preferably 6% to 13% by mass and more preferably 8% to 12% by mass.

In addition, it is difficult to balance sublimation performance of C.I. Disperse Blue 56 and sublimation performance of a sublimable dye with another color at a time of sublimation transfer to fabric, and balance with another color is difficult to achieve. However, balance with another color is easily achieved by the configuration of the cyan toner of the present disclosure. Since balance with a sublimable dye with another color is easily achieved, multiple dyes suitable for sublimation transfer can be used in combination for adjusting color tone.

The “dyes suitable for sublimation transfer” refer to dyes graded as usually grade 3 to grade 4 or lower, preferably grade 3 or lower in test results of the dry heat treatment test (C method) contamination (polyester) in “test methods for color fastness to dry heat JIS L0879:2005 (confirmed in 2010, revised on Jan. 20, 2005, issued by Japanese Standards Association).” Among such dyes, examples of known dyes include the following dyes.

Yellow dyes include C.I. Disperse Yellow 3, 7, 8, 23, 39, 51, 54, 60, 71, 86, C.I. Solvent Yellow 114, 163, and the like.

Orange dyes include C.I. Disperse Orange 1, 1:1, 5, 20, 25, 25:1, 33, 56, 7, and the like.

Brown dyes include C.I. Disperse Brown 2 and the like.

Red dyes include C.I. Disperse Red 11, 50, 53, 55, 55:1, 59, 60, 65, 70, 75, 93, 146, 158, 190, 190:1, 207, 239, 240, C.I. Vat Red 41, and the like.

Violet dyes include C.I. Disperse Violet 8, 17, 23, 27, 28, 29, 36, 57, and the like.

Blue dyes include C.I. Disperse Blue 19, 26, 26:1, 35, 55, 56, 58, 64, 64:1, 72, 72:1, 81, 81:1, 91, 95, 108, 131, 141, 145, 359, 360, C.I. Solvent Blue 3, 63, 83, 105, 111, and the like.

The content ratio of a sublimable dye with another color is about 0% to 3% by mass based on the toner particles.

### (1-3) Mold Release Agent

The mold release agent included in the toner particles of the cyan toner of the present disclosure has a melting point equal to or higher than 70° C. and equal to or lower than the softening point Tm of the cyan toner.

When the melting point of the mold release agent is less than 70° C., heat resistance characteristics of the toner may deteriorate. On the other hand, when the melting point of the mold release agent exceeds the softening point Tm of the toner, mold release properties become poor during a step of fixation to transfer paper, causing hot offset; and the toner is softened before a layer of the mold release agent is formed at the boundary between a toner layer and a heated surface during sublimation transfer to fabric, components other than the dye migrate to the fabric, and friction fastness may deteriorate.

The softening point Tm of the cyan toner of the present disclosure is determined by constituents blended to the toner particles and blending amounts thereof based on the softening point of the binder resin to be a base material of the toner particles, and is usually about 100° C. to 140° C. The melting point of the mold release agent is preferably 85° C. to 115° C. When the melting point of the mold release agent is less than 85° C., bleeding easily occurs. On the other hand, when the melting point of the mold release agent exceeds 115° C., fixability may decrease.

A measurement method for the melting point of the mold release agent and the softening point Tm of the cyan toner will be described in the examples.

The mold release agent is not particularly limited as long as it has the above described thermal properties, and a mold release agent commonly used in the art can be used. Examples thereof include a synthetic ester wax, carnauba wax, and a hydrocarbon-based wax, and a hydrocarbon-based wax is preferable among them from the point that proper compatibility with the styrene-acrylic resin, which is the binder resin, is provided.

In the cyan toner of the present disclosure, one kind of these mold release agents may be used singly, or two or more kinds thereof may be used in combination.

The hydrocarbon-based wax includes a non-polar hydrocarbon-based wax and a polar hydrocarbon-based wax.

Examples of the non-polar hydrocarbon-based wax include a polyolefin wax (a low molecular weight polyethylene, a low molecular weight polypropylene, a polyolefin copolymer, etc.), a paraffin wax, a microcrystalline wax, and a Fischer-Tropsch wax.

Examples of the polar hydrocarbon-based wax include an oxide of a non-polar hydrocarbon-based wax such as an oxidized polyethylene wax and an alcohol obtained by hydrolyzing the oxide.

Furthermore, examples of the polar hydrocarbon-based wax include saturated linear fatty acids such as palmitic acid, stearic acid, montanic acid, and long chain alkyl carboxylic acids having an alkyl group with a longer chain; unsaturated fatty acids such as brassidic acid, eleostearic acid, and parinaric acid; saturated alcohols such as stearyl alcohol, eicosyl alcohol, behenyl alcohol, carnaubil alcohol, ceryl alcohol, melissyl alcohol, and a long chain alkyl alcohol having an alkyl group with a longer chain; polyhydric alcohols such as sorbitol; fatty acid amides such as linoleic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebis oleic acid amide, hexamethylenebis oleic acid amide,

N,N′-dioleyladipic acid amide, and N,N′-dioleylsebacic acid amide; aromatic bisamides such as m-xylenebisstearic acid amide and N,N′-distearylisophthalic acid amide; and waxes obtained by grafting an aliphatic hydrocarbon-based wax using a vinyl-based monomer such as styrene or acrylic acid.

Among these mold release agents, a hydrocarbon-based wax selected from a polyolefin wax, a paraffin wax, and a Fischer-Tropsch wax is especially preferable from the points that compatibility with the styrene-acrylic resin, which is the binder resin, is proper, bleeding characteristics of the mold release agent during fixation is high, and mold release effect is high.

The mold release agent preferably has a dispersion diameter of 250 to 1500 nm.

When the dispersion diameter of the mold release agent is less than 250 nm, the mold release agent bleeds onto a surface during fixation to transfer paper, the original effect of the mold release agent that releasability from a fixing roller is enhanced is made less effective, and the fixability to transfer paper may become poor. On the other hand, when the dispersion diameter of the mold release agent exceeds 1500 nm, the area of the mold release agent exposed on a toner surface increases, and heat resistance characteristics as a toner may deteriorate.

The dispersion diameter of the mold release agent is preferably 300 to 1200 nm and more preferably 500 to 1000 nm.

A measurement method for the dispersion diameter of the mold release agent will be described in the examples.

The content of the mold release agent in the toner particles is not particularly limited, can be appropriately selected according to a purpose, and is preferably 3% to 10% by mass.

When the content of the mold release agent is less than 3% by mass, a layer of the mold release agent is not formed enough when an image formed on transfer paper is thermally transferred to fabric, components other than the dye migrate to the fabric, and friction fastness of the fabric after sublimation transfer may deteriorate. On the other hand, when the content of the mold release agent exceeds 10% by mass, the mold release agent is made difficult to disperse, the area of the mold release agent exposed on a surface increases, and heat resistance characteristics of the toner may deteriorate.

The content of the mold release agent is more preferably 3% to 8% by mass and still more preferably 4% to 6% by mass.

When the mold release agent in the toner particles has the above-described thermal properties, and the content thereof falls within the above-described ranges, excellent preservability is imparted to the toner particles (core particles), a wax layer is firmly formed between a toner layer and fabric during sublimation transfer to the fabric to suppress migration of toner components to the fabric, and friction fastness of the fabric can be sufficiently improved.

### (1-4) Others (Additives)

The toner particles of the cyan toner of the present disclosure may include a known additive within a range not impairing the effects of the present disclosure, if needed.

### (1-4-1) Polymer-Based Dispersant

It is preferable that the toner particles of the cyan toner of the present disclosure further include a polymer-based dispersant as a dye dispersant for the purpose of enhancing dispersibility of the dye.

When the polymer-based dispersant is used, an adsorption part of the dispersant adsorbs to the dye, rendering the dye highly dispersed in the binder resin and stable because of steric hindrance effect, and sublimation performance of the dye is thus enhanced, and a dye bleeding phenomenon of the dye steeping onto a surface when the toner is stored at high temperature can be suppressed.

The content of the polymer-based dispersant in the toner particles is not particularly limited, can be appropriately selected according to a purpose, and is preferably 0.1% to 2.0% by mass in general.

When the content of the polymer-based dispersant is less than 0.1% by mass, dye dispersing effect may not be provided enough. On the other hand, when the content of the polymer-based dispersant exceeds 2.0% by mass, the excess dispersant may negatively affect heat resistance characteristics and electrification performance as the toner.

The content of the polymer-based dispersant is more preferably 0.3% to 1.7% by mass and still more preferably 0.5% to 1.5% by mass.

### (1-4-2) Silica Particles

It is preferable that the toner particles of the cyan toner of the present disclosure further include silica particles inside thereof.

When the silica particles are included inside the toner particles, kneading strength is increased during melting and kneading, dye dispersibility and wax dispersibility can be improved, sublimation efficiency is enhanced, and heat resistance characteristics can be improved. Silica particles usually used as an external additive in the art can be used as the silica particles. In particular, silica particles to which hydrophobicity is imparted by subjecting same to surface treatment with a silane coupling agent are preferable because aggregation of silica can be suppressed.

The silica particles preferably have an average primary particle diameter of 7 to 60 nm. When the average primary particle diameter of the silica particles is less than 7 nm, secondary aggregates of silica is made difficult to suppress, making it difficult to disperse particles with a diameter of less than 7 nm in a state of keeping the primary particle diameter thereof as a practical matter. On the other hand, when the average primary particle diameter of the silica particles exceeds 60 nm, the above-described effects may not be provided enough.

The average primary particle diameter of the silica particles is more preferably 7 to 30 nm and still more preferably 7 to 15 nm.

The content of the silica particles in the toner particles is not particularly limited, can be appropriately selected according to a purpose, and is preferably 0.1% to 1.0% by mass in general.

When the content of the silica particles is less than 0.1% by mass, the above-described effects may not be provided enough. On the other hand, when the content of the silica particles exceeds 1.0% by mass, fixation performance during fixation to transfer paper may deteriorate.

The content of the silica particles is more preferably 0.2% to 0.9% by mass and still more preferably 0.3% to 0.8% by mass.

### (1-4-3) Charge Control Agent

The toner particles of the cyan toner of the present disclosure preferably includes a charge control agent in the toner particles.

The charge control agent is not particularly limited, but a charge control agent for controlling positive charge and a charge control agent for controlling negative charge commonly used in the art can be used.

Examples of the charge control agent for controlling positive charge include nigrosine dyes, basic dyes, quaternary ammonium salts, quaternary phosphonium salts, aminopyrine, pyrimidine compounds, polynuclear polyamino compounds, aminosilane, nigrosine dyes and derivatives thereof, triphenylmethane derivatives, guanidine salts, and amidine salts.

Examples of the charge control agent for controlling negative charge include oil-soluble dyes such as oil black and spilon black, metal-containing azo compounds, azo complex dyes, metal naphthenates, salicylic acid and metal complexes and metal salts of derivatives of salicylic acid (metal is chromium, zinc, zirconium, etc.), boron compounds, fatty acid soap, long chain alkyl carboxylic acid salts, and resin acid soap.

In the cyan toner of the present disclosure, one kind of the charge control agent described above may be used alone, or two or more kinds thereof may be used in combination.

The content of the charge control agent in the toner particles is not particularly limited, depends on the type of the binder resin, presence or absence of other additives, dispersion manner, and the like, and is difficult to unambiguously define, but may be appropriately selected according to a purpose, and is preferably 0.5% to 3.0% by mass and more preferably 0.7% to 2.5% by mass.

When the content of the charge control agent falls within the above ranges, an image having a high image concentration and extremely high image quality can be formed without impairing various physical properties of the toner.

### (1-5) External Additive

An external additive may be externally added to the toner particles of the present disclosure, the external additive serving a function of powder flowability improvement, friction electrification improvement, heat resistance, long-term preservability improvement, cleaning characteristic improvement, photoreceptor surface abrasion characteristic control, or the like.

The external additive is not particularly limited, but various external additives commonly used in the art can be used, and two or more external additives may be used in combination. Examples of the external additive include fine particles such as silica fine particles, titanium fine oxide particles, and alumina fine particles each having an average particle diameter of 5 to 200 nm. In particular, inorganic fine particles to which hydrophobicity is imparted by subjecting same to surface treatment with a silane coupling agent, a titanium coupling agent, or silicone oil are preferable. Surface-treated inorganic fine particles can suppress decrease in electric resistance and charge amount under high humidity. Among inorganic fine particles, silica particles with a volume average particle diameter of 15 nm or less is particularly preferable from the point that flowability and heat resistant preservability of the toner particles can be appropriately improved.

The external addition amount of the external additive added to the toner particles is not particularly limited and is usually 0.5% to 3.0% by mass.

When the external addition amount of the external additive is less than 0.5% by mass, it may be difficult to impart flowability improving effect. On the other hand, when the external addition amount of the external additive exceeds 3.0% by mass, fixability may deteriorate.

The external addition amount of the external additive is preferably 1.0% to 2.5% by mass and more preferably 1.2% to 2.3% by mass.

### (2) Cyan Toner Production Method

The cyan toner of the present disclosure can be produced by a known method and can be produced through, for example: a mixing and kneading step of mixing raw materials of the toner particles, which are at least a binder resin, a sublimable dye, and a mold release agent and an additive (internal additive) optionally blended such as a charge control agent, and melting and kneading same; a coarsely pulverizing step of coarsely pulverizing the obtained melt kneaded product; a finely pulverizing step of finely pulverizing the obtained coarsely pulverized product; and a classifying step of classifying the obtained finely pulverized product. Although the cyan toner production method of the present disclosure is not limited to the above-described method, dry methods are preferable because the number of steps is small and costs for equipment are low compared to wet methods, and a melting and kneading method (pulverization method) is particularly preferable among others.

Conditions for each of the above-desired steps may be appropriately set according to a target material and desired physical properties.

### (2-1) Mixing and Kneading Step

In the mixing and kneading step, toner materials including at least the binder resin, the sublimable dye, and the mold release agent and a known additive such as the charge control agent optionally blended are mixed and melt and kneaded to obtain a melt kneaded product. Dry mixing is preferable, a known device commonly used in the art can be used as a mixer, and examples thereof include a Henschel-type mixing device such as Henschel mixer (product name, manufactured by Mitsui Mining Co., Ltd. (current Nippon Coke and Engineering Co., Ltd.)), SUPER MIXER (product name, KAWATA MFG. CO., LTD.), and MECHANOMILL (product name, manufactured by Okada Seiko Co., Ltd.); and a mixing device such as Ongmill (product name, manufactured by Hosokawa Micron Corporation), Hybridization System (product name, manufactured by Nara Machinery Co., Ltd.), and Cosmo System (product name, manufactured by Kawasaki Heavy Industries, Ltd.).

Kneading is carried out with heating to a temperature equal to or higher than the softening point Tm of the binder resin and less than pyrolysis temperature. Consequently, the binder resin is melted or softened, and the sublimable dye, the mold release agent, the charge control agent, and the like can be dispersed in the binder resin. The heating temperature during kneading is preferably 80° C. to 200° C. and more preferably 120° C. to 160° C.

A known device commonly used in the art can be used as a kneader, and examples thereof include general kneaders such as a kneader, a twin-screw extruder, a two roll mill, a three roll mill, and a Labo Plastomill. Specifically, examples thereof include a single or twin-screw extruder such as TEM-100B (product name, manufactured by Toshiba Machine Co., Ltd.), PCM-65/87, and PCM-30 (which are all product models, manufactured by Ikegai Corp) and an open roll kneader such as Kneadex (product name, manufactured by Mitsui Mining Co., Ltd.). Among them, an open roll kneader is preferable from the points of providing strong shear during kneading and being capable of highly dispersing the disperse dye. Multiple kneaders may be used in combination.

### (2-2) Coarsely Pulverizing Step and Finely Pulverizing Step

In the coarsely pulverizing step, the melt kneaded product cooled and solidified by a drum flaker or the like is coarsely pulverized to obtain a coarsely pulverized product.

A known device commonly used in the art can be used as a pulverizer for coarse pulverization, and examples thereof include a speed mill, a hammer mill, and a cutter mill (cutting mill, manufactured by orient corporation, model: VM-16).

In the finely pulverizing step, the coarsely pulverized product obtained in the coarsely pulverizing step is finely pulverized.

A known device commonly used in the art can be used as a pulverizer, and examples thereof include a jet pulverizer conducting pulverization utilizing an ultrasound jet airflow and an impact pulverizer conducting pulverization by introducing a solidified material into a space formed between a rotator (rotor) rotating at high speed and a stator (liner).

### (2-3) Classifying Step

In the classifying step, the finely pulverized product obtained in the finely pulverizing step is classified to obtain, for example, a fine particle group having a volume average particle diameter of 4 to 10 μm.

A known device commonly used in the art, in particular, a classifier capable of removing excessively pulverized toner particles by centrifugal force and wind power like a wind power slewing classifier (wind power rotary classifier) can be used for classification, and examples thereof include an elbow jet classifier (manufactured by Nittetsu Mining Co., Ltd., model: EJ-LABO).

The classifying step may not carried out, and a finely pulverized particle group obtained in the pulverizing step may be collected as toner particles.

### (2-4) External Addition Step

In an external addition step, the fine particle group (toner particles) obtained in the classifying step and an external additive are mixed using a mixer, and the external additive is attached to each fine particle surface to collect same as a toner (externally added toner).

A known device commonly used in the art can be used as the mixer, and examples thereof include the mixers described in section (2-1) pertaining to the mixing and kneading step.

In the above manner, the toner to which an external additive is externally added if needed can be directly used as a one component developer or can be mixed with a carrier and used as a two component developer. When the toner is used as a one component developer, the toner is used alone without using a carrier. In the case where the toner is used as a one component developer, an image is formed, using a blade and a fur brush, in a manner that the toner is triboelectrically charged with a developing sleeve and attached onto the sleeve, and the toner is thereby conveyed.

### (3) Two Component Developer

The two component developer of the present disclosure includes the cyan toner of the present disclosure and a carrier.

The two component developer of the present disclosure can be produced by mixing the cyan toner of the present disclosure and the carrier.

A known device commonly used in the art can be used as a mixing device, and examples thereof include a power mixer such as a V-type mixer (model: V-5, manufactured by TOKUJU CORPORATION).

A blending ratio between the cyan toner and the carrier is not particularly limited and is, for example, 3:97 to 12:88 in terms of mass ratio. That is, the toner concentration in the two component developer is preferably 3% to 12% by mass.

The carrier is mixed with the toner and stirred within a developer tank to provide the toner with a desired charge. The carrier also functions as an electrode between a developing device and a photoconductor, and serves to carry the charged toner to an electrostatic latent image on the photoconductor and to form a toner image. The carrier is held on a developing roller of the developing device with magnetic force, acts on developing, then returns to the developer tank again, and is mixed with a new toner and stirred again to be repeatedly used until the life-span thereof expired.

The carrier is not particularly limited, a carrier usually used for two component developers can be used, and a coated carrier as described in the examples can be used, for example.

The carrier has a carrier core material, and a resin coating layer coating the carrier core material.

The carrier core material is not particularly limited as long as it is used in the art, and examples thereof include magnetic metals such as iron, copper, nickel, and cobalt, and magnetic metal oxides such as ferrite and magnetite.

The resin coating layer preferably includes a silicone resin or an acrylic resin. The silicone resin can slow down progression of contamination in a carrier coat layer, and is suitable for use in long-life applications.

The volume average particle diameter of the carrier core material is not particularly limited and is 30 to 100 μm, for example.

### EXAMPLES

The present disclosure will be specifically described below with reference to production examples, examples, and comparative examples, but the present disclosure is not limited to the following examples unless it does not depart from the spirit thereof.

In the production examples, examples, and comparative examples, the respective physical property values are measured by the methods described below.

### Identification of Sublimable Dye C.I. Disperse Blue 56

“C.I. Disperse Blue 56” in a toner can be identified by the following analyses (1) and (2).

### (1) GC/MS Analysis

A cyan toner to be evaluated is placed in a pyrolysis GC/MS device (manufactured by Agilent Technologies, Inc., model: 7890A/5975C) and analyzed under the following conditions.

Column: HP-5 MS (non-polar column)

Inlet temperature: 320° C.

Split ratio: 100:1

Gas flow rate: 15 mL/minute

Column flow rate: 1 mL/minute

Temperature rising conditions: initial temperature 40° C., one minute→(increasing temperature 20° C./minute)→reaching temperature 320° C., keeping 5 minutes

Sample amount: 20 mg

A peak is detected at a retention time of 17.2 [minutes] to identify “C.I. Disperse Blue 56.”

### (2) Transmittance Measurement by Ultraviolet-Visible Spectrophotometer

A sample is prepared by sandwiching a cyan toner to be evaluated between two prepared slides, followed by thermocompression bonding. The obtained sample is placed in an ultraviolet-visible spectrophotometer (manufactured by SHIMADZU CORPORATION, model: UV-2450), and transmittance is measured in a wavelength range of 780 to 380 nm. “C.I. Disperse Blue 56” is identified from a maximum absorption wavelength present in the wavelengths range of 570 to 640 nm and from the wavelength at which the transmittance reaches maximum present at a wavelength of 430 nm.

Transparency of cyan toner (transmittance at wavelength of 430 nm)

A sample is prepared by sandwiching a cyan toner to be evaluated between two prepared slides, followed by thermocompression bonding. The obtained sample is placed in an ultraviolet-visible spectrophotometer (manufactured by SHIMADZU CORPORATION, model: UV-2450), and a point at which the transmittance is 3% with reference to the maximum absorption wavelength is determined for the wavelength range of 780 to 380 nm to determine the transmittance at a wavelength of 430 nm. Evaluation can be made as follows: the higher the transmittance is, the less the fewer the aggregates of the sublimable dye, and the better the dye dispersibility becomes.

### Melting Point of Mold Release Agent

DSC curves were obtained, using a differential scanning calorimeter (manufactured by Seiko Instruments & Electronics Ltd. (current Seiko Instruments Inc.), model: DSC220), by repeating the following operation twice: 1 g of a sample was heated from a temperature of 20° C. to 200° C. at a temperature increasing ratio of 10° C./minute and then quickly cooled from 200° C. to 20° C. The temperature at the endothermic peak corresponding to melting in the DSC curve obtained in the second operation is taken as the melting point of the mold release agent.

### Softening Point Tm of Toner

Using a flow property evaluation device (flow tester, manufactured by SHIMADZU CORPORATION, model: CFT-100C), 1 g of a sample is flowed out of a die (nozzle diameter: 1 mm, length: 1 mm) by applying a load of 20 kgf/cm² (9.8×10⁵ Pa) while heating the sample from an initial temperature of 40° C. at a temperature increasing rate of 6° C./minute. The temperature at which half the amount of the sample has been flowed out is taken as the softening point Tm.

### Dispersion Diameter of Mold Release Agent

A prepared cyan toner was embedded in epoxy resin, and a sample was prepared by sectioning with an ultramicrotome (manufactured by Reichert, Inc., product mane: ULTRACUT N). The obtained sample was observed with a scanning electron microscope (manufactured by Hitachi High-Tech Corporation, model: S-4800) to measure the wax dispersion diameter. From the obtained electron micrograph data, 200 to 300 wax portions were randomly extracted and subjected to image analysis with image analysis software (product name: A-zou kun, produced by Asahi Kasei Engineering Corporation) to obtain an equivalent circle diameter.

### Production Example 1: Synthesis of Styrene-Acrylic Resin SA1

Into a flask after nitrogen substitution were added 74 parts by mass of styrene, 26 parts by mass of n-butyl acrylate, and 1.0 parts by mass of methacrylic acid, the internal temperature was increased to 120° C., and bulk polymerization was subsequently carried out for 10 hours. Thereafter, 80 parts by mass of xylene was added, 20 parts by mass of a xylene solution in which 1.5 parts by mass of di-t-butyl peroxide was uniformly dissolved was continuously added over 8 hours while keeping the temperature at 130° C., and the mixture was flashed into a vessel at a temperature of 90° C. and a pressure of 10 mmHg to remove the solvent and the like, followed by coarse pulverizing using a coarse pulverizing device to obtain styrene-acrylic resin “SA1.” The softening point Tm of resin “SA1” was 140° C.

### Production Example 2: Synthesis of Styrene Acrylic Resin SA2

To a reaction vessel with a volume of 5 L, 20 parts by mass of a xylene solution in which 1.5 parts by mass of di-t-butyl peroxide was uniformly dissolved in a solution including 74 parts by mass of styrene, 26 parts by mass of n-butyl acrylate, and, as a solvent, 80 parts by mass of xylene was continuously supplied at 750 mL/hour, while keeping the internal temperature of 180° C. and an internal pressure of 6 kg/cm² in the reaction vessel, and polymerization was allowed to proceed to obtain a solution of a styrene-acrylic resin. Thereafter, the mixture was flashed into a vessel at a temperature of 90° C. and a pressure of 10 mmHg to remove the solvent and the like, followed by coarse pulverizing using a coarse pulverizing device to obtain styrene-acrylic resin “SA2.” The softening point Tm of resin “SA2” was 120° C.

### Production Example 3: Synthesis of Polyester Resin PE1

Into a reaction tank with a volume of 5 L were put 440 parts by mass of terephthalic acid, 235 parts by mass of isophthalic acid, 7 parts by mass of adipic acid, 554 parts by mass of ethylene glycol, and, as a polymerization catalyst, 0.5 parts by mass of tetrabutoxy titanate, and reaction was allowed to proceed for 5 hours at a temperature of 210° C. and under nitrogen airflow, while distilling generated water and ethylene glycol off. Thereafter, reaction was allowed to proceed for 1 hour under a reduced pressure of 5 to 20 mmHg.

Then, 103 parts by mass of trimellitic anhydride was added, reaction was allowed to proceed for 1 hour under ordinary pressure, reaction was subsequently allowed to proceed under a reduced pressure of 20 to 40 mmHg, and resin was taken out at a predetermined softening point Tm of 130° C. The obtained resin was cooled to room temperature, followed by particulation through pulverization to obtain polyester-based resin “PE 1.”

### Production Example 4: Preparation of Resin-Coated Carrier

A coating resin solution was prepared by dissolving, in 12 parts by mass of toluene, 0.375 parts by mass of coating resin 1 (silicone-base, manufactured by Shin-Etsu Chemical Co., Ltd., product name: KR240) and 0.375 parts by mass of coating resin 2 (manufactured by Shin-Etsu Chemical Co., Ltd., product name: room temperature drying methyl-based resin KR251), and internally adding thereto or dispersing therein 0.0375 parts by mass of conductive particles (manufactured by Cabot Corporation, product name: VULCAN XC-72) and 0.0225 parts by mass of a coupling agent (manufactured by Dow Corning Toray Co., Ltd., product name: AY43-059).

Surfaces of 100 parts by mass of a ferrite carrier core material with a volume average particle diameter of 40 μm were coated using 12.8 parts by mass of the coating resin solution through an immersion method. Thereafter, after a curing process at a curing temperature of 200° C. for a curing time of 1 hour, a resin-coated carrier was obtained through sieving with a sieve with a mesh size of 150 μm.

### Example 1: Production of Toner Particles, Externally Added Toner, and Two Component Developer Mixing and Kneading Steps

Binder resin (SA1 of Production Example 1, Tm: 140° C. 84.0 mass %

Sublimable dye (C.I. Disperse Blue 56) 10.0 mass %

Charge control agent (salicylic acid-based compound, manufactured by ORIENT CHEMICAL INDUSTRIES CO., LTD., product name: BONTRON E-84) 1.0 mass %

Mold release agent (Fischer-Tropsch wax, melting point (condensation point): 90° C., manufactured by NIPPON SEIRO CO., LTD., product name: FT wax FNP-0090) 5.0 mass %

The above materials were pre-mixed for 5 minutes using Henschel mixer (manufactured by Mitsui Mining Co., Ltd. (current Nippon Coke and Engineering Co., Ltd.), model: FM20C) and then melt and kneaded under the following conditions using an open roll-type continuous kneader (manufactured by Mitsui Mining Co., Ltd., model: MOS320-1800) to obtain a melt kneaded product.

Supply side temperature/discharge side temperature of heating roll: 130° C./100° C.

Supply side temperature/discharge side temperature of cooling roll: 40° C./25° C.

Heating roll and cooling roll: diameter 320 mm, effective length 1550 mm

Gap between rolls on supply side and discharge side: 0.3 mm

Heating roll rotational speed/cooling roll rotational speed: 75 rpm/65 rpm

Supply speed of toner raw material: 5.0 kg/hour

### Coarsely Pulverizing and Finely Pulverizing Steps

The obtained melt kneaded product was cooled with a cooling belt and subsequently coarsely pulverized using a power mill (manufactured by DALTON CORPORATION, model: P-3) having a screen with a diameter of 2 mm to obtain a coarsely pulverized product.

The obtained coarsely pulverized product was finely pulverized using a jet pulverizer (manufactured by Nippon Pneumatic Mfg. Co., Ltd., model: IDS-2) to obtain a finely pulverized product.

### Classifying Step

Thereafter, the obtained finely pulverized product was classified using Elbow-Jet classifier (manufactured by Nittetsu Mining Co., Ltd., model: EJ-LABO) to obtain toner particles having an average primary particle diameter of 6.7 μm.

The softening point Tm of the obtained toner was 120° C., the transmittance at a wavelength of 430 nm measured by the ultraviolet-visible spectrophotometer was 40%, and the dispersion diameter of the mold release agent was 500 nm.

### External Addition Step

Into Henschel mixer were put 100 parts by mass of toner particles (toner base particles) with no additive externally added thereto and 1.5 parts by mass of hydrophobic silica fine particles (average primary particle diameter: 7 μm, surface-treated with dimethyldichlorosilane, manufactured by NIPPON AEROSIL CO., LTD., product name: R976S) (amount of external additive based on toner particles: 1.5% by mass), and the circumferential velocity in the outermost periphery of a tip end part of a stirring blade was set to 40 m/second, followed by stirring and mixing for one minute to obtain 2000 g of an externally added toner.

### Two Component Developer Production Step

The obtained externally added toner and the resin-coated carrier obtained in Production Example 3 were adjusted such that the concentration of the externally added toner based on the total amount of a two component developer to be produced became 7% by mass, and mixed for 20 minutes using a V-type mixer (product name: V-5, manufactured by Tokuju Corporation) to obtain 2000 g of a two component developer with a toner concentration of 7% by mass.

### Examples 2 to 12

Toner particles, externally added toners, and two component developers were obtained in the same manner as Example 1 except that the constituents (materials and blending amounts thereof) for the toner particles were changed to those shown in Table 1, and melting and kneading conditions (only Example 4) were changed as follows.

The blending ratio of the binder resin was changed to adjust the total amount of the toner particles according to the blending ratios of the sublimable dye and the mold release agent and the polymer-based dispersant and the silica particles.

In Example 2, the mold release agent was changed to a mold release agent (paraffin wax, melting point: 74° C., manufactured by NIPPON SEIRO CO., LTD., product name: HNP series HNP-10).

In Example 3, the styrene-acrylic resin as the binder resin was changed to SA2 (softening point: 120° C.) of Production Example 2, and the mold release agent was changed to a mold release agent (polyethylene wax, melting point: 104° C., manufactured by TOYOCHEM CO., LTD., product name: PW725).

In Example 4, in the mixing and kneading step in toner particle production, after materials were pre-mixed using Henschel mixer, melting and kneading were carried out at a cylinder setting temperature of 140° C., barrel rotational speed of 200 rpm, and raw material supply speed of 15 kg/hour using a twin-screw extruder (manufactured by Ikegai Corp, model: PCM-30) to obtain a melt kneaded product. That is, in Example 4, the melting and kneading conditions were set to be weaker than those in Example 1.

In Example 5, the mold release agent was changed to a mold release agent (polyethylene wax, melting point: 104° C., manufactured by TOYOCHEM CO., LTD., product name: PW725), and the blending amount thereof was changed to 7% by mass.

In Example 6, the mold release agent was changed to a mold release agent (polyolefin wax, melting point: 125° C., manufactured by Sanyo Chemical Industries, Ltd., product name: SANWAX LEL-250).

In Examples 7 and 8, the blending amount of C.I. Disperse Blue 56 as the sublimable dye was changed to 5% by mass and 15% by mass, respectively.

In Examples 9 to 12, the blending amount of the mold release agent was changed to 3% by mass, 10% by mass, 2% by mass, and 12% by mass, respectively.

### Examples 13 and 14

In Examples 13 and 14, 1% by mass of a polymer-based dispersant (melting point: 105° C., manufactured by Lubrizol Corporation, product name: Solplus DP370) and 1% by mass of a polymer-based dispersant (melting point: 50° C., manufactured by Lubrizol Corporation, product name: Solplus L400) were further blended to the toner particle constituents, respectively.

### Examples 15 to 19

In Examples 15 to 17, 0.5% by mass, 1.0% by mass, and 1.5% by mass of hydrophobic silica fine particles (average primary particle diameter: 7 nm, surface-treated with dimethyldichlorosilane, manufactured by NIPPON AEROSIL CO., LTD., product name: R976S) were further blended to the toner particle constituents, respectively.

In Examples 18 and 19, silica fine particles with different particle diameters, 0.5% by mass of silica fine particles (average primary particle diameter: 50 nm, surface-treated with HMDS, manufactured by Shin-Etsu Chemical Co., Ltd., product name: X-24-9404) and 0.5% by mass of silica fine particles (average primary particle diameter: 110 nm, surface-treated with HMDS, manufactured by Shin-Etsu Chemical Co., Ltd., product name: X-24-9163A) were further blended to the toner particle constituents, respectively.

### Comparative Examples 1 to 6

Toner particles, externally added toners, and two component developers were obtained in the same manner as Example 1 except that the constituents (materials and blending amounts thereof) for the toner particles were changed to those shown in Table 1, and melting and kneading conditions (only Comparative Example 4) were changed as follows.

In Comparative Example 1, the binder resin was changed to polyester-based resin PE1 (Tm: 130° C.) of Production Example 3.

In Comparative Examples 2 and 3, the mold release agent was changed to a mold release agent (polyolefin wax, melting point: 150° C., manufactured by Sanyo Chemical Industries, Ltd., product name: VISCOL 550-P) and a mold release agent (high purity ester wax, melting point: 60° C., manufactured by NOF CORPORATION, product name: NISSAN ELECTOL WEP-2), respectively.

In Comparative Example 4, the blending amount of the mold release agent was changed to 8% by mass, and in the mixing and kneading step in toner particle production, after materials were pre-mixed using Henschel mixer, melting and kneading were carried out at a cylinder setting temperature of 140° C., barrel rotational speed of 200 rpm, and raw material supply speed of 15 kg/hour using a twin-screw extruder (manufactured by Ikegai Corp, model: PCM-30) to obtain a melt kneaded product. That is, in Comparative Example 4, the melting and kneading conditions were set to be weaker than those in Example 1.

In Comparative Examples 5 and 6, the blending amount of C.I. Disperse Blue 56 as the sublimable dye was changed to 3% by mass and 18% by mass, respectively.

### Evaluation 1: Sublimation Transfer Efficiency

Each two component developer and each toner prepared were respectively charged into a developing device and a toner cartridge of a color multifunction machine (manufactured by Sharp Corporation, model: BP-20C25), an A4 test manuscript having a rectangular solid image of 20 mm by 50 mm was copied to form an image on an intermediate recording medium (manufactured by Sharp Corporation, product name: PPC paper SF-4AM3S).

With respect to the intermediate recording medium obtained by two component development, the image concentration of the intermediate recording medium was measured before and after sublimation transfer through heat treatment at a temperature of 200° C. for one minute using a spectrophotometer (manufactured by GretagMacbeth LLC, product name: SpectroEye RD-19).

Sublimation transfer efficiency was calculated, using the following equation, from the image concentration IDb before transfer and the image concentration IDa after transfer of the image attached to the intermediate recording medium, and the sublimation transfer efficiency was evaluated according to the following criteria.

Sublimation transfer efficiency(%)=(IDb−IDa)/(IDb)×100

Excellent: 50% or more (possible to use practically)

Good: 45% or more and less than 50% (possible to use practically)

Fair: 40% or more and less than 45% (possible to use practically)

Poor: less than 40% (impossible to use practically)

### Evaluation 2: Concentration on Fabric

An image was formed on an intermediate recording medium (manufactured by Sharp Corporation, product name: PPC paper SF-4AM3S) in the same manner as in Evaluation 1. The obtained intermediate recording medium and satin fabric as polyester fabric were subjected to heat treatment at a temperature of 200° C. for 1 minute, and the intermediate recording medium was peeled from the fabric to obtain a fabric dyed product dyed through sublimation transfer.

Concentration at a certain filled location (the central portion of the above image (rectangular solid image of 20 mm by 50 mm)) of the image on the obtained dyed product was measured using a concentration meter (manufactured by X-Rite, Inc., spectrophotometric colorimeter/concentration meter, X-Rite eXact).

Concentration on fabric was evaluated on the basis of the measured concentration values according to the following criteria.

Excellent: 1.4 or more (possible to use practically)

Good: 1.3 or more and less than 1.4 (possible to use practically)

Fair: 1.2 or more and less than 1.3 (possible to use practically)

Poor: less than 1.2 (impossible to use practically)

### Evaluation 3: Fog on Fabric

An image was formed on an intermediate recording medium (manufactured by Sharp Corporation, product name: PPC paper SF-4AM3S) in the same manner as in Evaluation 2, and a fabric dyed product dyed through sublimation transfer was then obtained.

Whiteness at a certain location (the middle portion between the above image (rectangular solid image of 20 mm by 50 mm) and the end portion of the paper) filled with no image before and after sublimation transfer of the image to the fabric was measured using a colorimetry chromometer (manufactured by NIPPON DENSHOKU INDUSTRIES CO., LTD., model: ZE6000).

The difference in whiteness before sublimation transfer and after sublimation transfer was taken as a fog value (B. G.), and fog on the fabric was evaluated according to the following criteria.

Excellent: 0.5 or less (possible to use practically)

Fair: larger than 0.5 and 1.0 or less (possible to use practically)

Fair: larger than 1.0 and 1.5 or less (possible to use practically)

Poor: larger than 1.5 (impossible to use practically)

### Evaluation 4: Dry Friction Fastness

Each two component developer and each toner prepared were respectively charged into a developing device and a toner cartridge of a color multifunction machine (manufactured by Sharp Corporation, model: BP-20C25), and a monochroic image with a coverage of 100% was formed on an intermediate recording medium (manufactured by Sharp Corporation, product name: PPC paper SF-4AM3S).

The obtained intermediate recording medium and satin fabric as polyester fabric were subjected to heat treatment at a temperature of 200° C. for 1 minute, and the intermediate recording medium was peeled from the fabric to obtain a fabric dyed product (test fabric) dyed through sublimation transfer.

The obtained test fabric was subjected to a drying test (dry friction) using a II-type (Gakushin-type) friction tester (manufactured by TESTER SANGYO CO., LTD., model: Gakushin-type friction tester) in accordance with JIS L0849:2013, test methods for color fastness to rubbing, the staining degree of white fabric was determined based on comparison with a staining gray scale, and friction fastness was evaluated according to the following criteria.

The friction tester had a table, fabric to be tested was attached to the table, and cotton cloth was attached to the arm end (friction element) in an upper part of the friction tester. The fabric to be tested was subjected to friction through 100 cycles of 100 mm reciprocating movement, on the fabric to be tested, of the arm with the cotton cloth, while applying a load of about 200 g. The cotton cloth was detached from the arm after friction, and a numerical value of friction fastness was determined by judging “staining degree” using a staining gray scale. The numerical values are represented by grades, and a larger grade indicates higher friction fastness.

Excellent: grade 4.5 or greater (excellent, possible to use practically)

Good: grade 4 or greater (good, possible to use practically)

Fair: grade 3 or greater (possible to use practically)

Poor: grade 2 or lower (impossible to use practically)

Evaluation 5: heat resistant preservation stability of toner

Heat resistant preservation stability of a toner was evaluated on the basis of the presence or the absence of agglomerate after preservation at high temperature.

Into a plastic container having a volume of 250 mL and having a wide-mouthed cylindrical shape was put 20 g of the prepared externally added toner, the plastic container was sealed and left to stand under a temperature condition of 50° C. for 72 hours, and the externally added toner was then taken out and sieved by a 230-mesh sieve. The mass of the toner remaining on the sieve was measured, and the remaining amount, which was the ratio of the measured mass to the total mass of the toner, was obtained and evaluated according to the following criteria. The remaining amount indicates that the lower the numerical value thereof, the less blocking of the toner occurs.

Excellent: excellent (without aggregation, remaining amount: less than 0.5%)

Good: good (with minute amount of aggregates, remaining amount: 0.5% or more and less than 7%)

Fair: pass (with large amount of aggregates, remaining amount: 7% or more and less than 12%)

Poor: fail (with large amount of aggregates, remaining amount: 12% or more)

### Comprehensive Evaluation

From the results of Evaluations 1 to 5 above, an example with no result rated as “poor” among evaluation items was evaluated as “possible to use practically,” and an example with at least one result rated as “poor” among 5 evaluation items was evaluated as “impossible to use practically.”

Materials and contents thereof used for preparing the toners of Examples and Comparative Examples and transmittance at a wavelength of 430 nm of the obtained toners are shown in Table 1, and evaluation results of the obtained toners are shown in Table 2.

Materials are represented by alphanumeric characters of the product names thereof or by part of the alphanumeric characters in Tables 1 and 2.

TABLE 1

| | Toner | | | | | | | | | | | | | |
|---|---|---|---|---|---|---|---|---|---|---|---|---|---|---|
| | | | | | | | | | | | | | | Trans- |
| | | | | | | | | | | | | | | mittance |
| | Constituents | | | | | | | | | | | | | at |
| | Bind- | Sub- | Mold release agent | | | | Polymer dispersant | | | Silica particle | | | Soft- | wave- |
| | er | limable | | Melt- | Disper- | | | Melt- | | | Particle | | ening | length |
| | resin | dye | | ing | sion | | | ing | Addition | | diam- | Addition | point | of |
| | Mate- | Content | Mate- | point | diameter | Content | Mate- | point | amount | Mate- | eter | amount | Tm | 430 nm |
| | rial | (mass %) | rial | (° C.) | (nm) | (mass %) | rial | (° C.) | (mass %) | rial | (nm) | (mass %) | (° C.) | (%) |
| Exam- | SA1 | 10 | FNP0090 | 90 | 500 | 5 | — | — | — | — | — | — | 120 | 40 |
| ple 1 | | | | | | | | | | | | | | |
| Exam- | SA1 | 10 | HNP-10 | 74 | 500 | 5 | — | — | — | — | — | — | 117 | 40 |
| ple 2 | | | | | | | | | | | | | | |
| Exam- | SA2 | 10 | PW725 | 104 | 1000 | 5 | — | — | — | — | — | — | 108 | 40 |
| ple 3 | | | | | | | | | | | | | | |
| Exam- | SA1 | 10 | FNP0090 | 90 | 1200 | 5 | — | — | — | — | — | — | 130 | 31 |
| ple 4 | | | | | | | | | | | | | | |
| Exam- | SA1 | 10 | PW725 | 104 | 1500 | 7 | — | — | — | — | — | — | 125 | 37 |
| ple 5 | | | | | | | | | | | | | | |
| Exam- | SA1 | 10 | LEL-250 | 125 | 2000 | 5 | — | — | — | — | — | — | 127 | 37 |
| ple 6 | | | | | | | | | | | | | | |
| Exam- | SA1 | 5 | FNP0090 | 90 | 500 | 5 | — | — | — | — | — | — | 120 | 45 |
| ple 7 | | | | | | | | | | | | | | |
| Exam- | SA1 | 15 | FNP0090 | 90 | 500 | 5 | — | — | — | — | — | — | 120 | 34 |
| ple 8 | | | | | | | | | | | | | | |
| Exam- | SA1 | 10 | FNP0090 | 90 | 400 | 3 | — | — | — | — | — | — | 122 | 42 |
| ple 9 | | | | | | | | | | | | | | |
| Exam- | SA1 | 10 | FNP0090 | 90 | 1500 | 10 | — | — | — | — | — | — | 117 | 37 |
| ple 10 | | | | | | | | | | | | | | |
| Exam- | SA1 | 10 | FNP0090 | 90 | 300 | 2 | — | — | — | — | — | — | 124 | 43 |
| ple 11 | | | | | | | | | | | | | | |
| Exam- | SA1 | 10 | FNP0090 | 90 | 1800 | 12 | — | — | — | — | — | — | 115 | 34 |
| ple 12 | | | | | | | | | | | | | | |
| Exam- | SA1 | 10 | FNP0090 | 90 | 500 | 5 | DP370 | 105 | 1 | — | — | — | 120 | 45 |
| ple 13 | | | | | | | | | | | | | | |
| Exam- | SA1 | 10 | FNP0090 | 90 | 500 | 5 | L400 | 50 | 1 | — | — | — | 119 | 45 |
| ple 14 | | | | | | | | | | | | | | |
| Exam- | SA1 | 10 | FNP0090 | 90 | 400 | 5 | — | — | — | R976S | 7 | 0.5 | 122 | 43 |
| ple 15 | | | | | | | | | | | | | | |
| Exam- | SA1 | 10 | FNP0090 | 90 | 300 | 5 | — | — | — | R976S | 7 | 1.0 | 125 | 43 |
| ple 16 | | | | | | | | | | | | | | |
| Exam- | SA1 | 10 | FNP0090 | 90 | 200 | 5 | — | — | — | R976S | 7 | 1.5 | 132 | 40 |
| ple 17 | | | | | | | | | | | | | | |
| Exam- | SA1 | 10 | FNP0090 | 90 | 450 | 5 | — | — | — | 9404 | 50 | 0.5 | 121 | 38 |
| ple 18 | | | | | | | | | | | | | | |
| Exam- | SA1 | 10 | FNP0090 | 90 | 500 | 5 | — | — | — | 9163A | 110 | 0.5 | 120 | 35 |
| ple 19 | | | | | | | | | | | | | | |
| Com- | PE1 | 10 | FNP0090 | 90 | 1000 | 5 | — | — | — | — | — | — | 115 | 50 |
| par- | | | | | | | | | | | | | | |
| ative | | | | | | | | | | | | | | |
| Exam- | | | | | | | | | | | | | | |
| ple 1 | | | | | | | | | | | | | | |
| Com- | SA1 | 10 | 550-P | 150 | 800 | 5 | — | — | — | — | — | — | 125 | 40 |
| par- | | | | | | | | | | | | | | |
| ative | | | | | | | | | | | | | | |
| Exam- | | | | | | | | | | | | | | |
| ple 2 | | | | | | | | | | | | | | |
| Com- | SA1 | 10 | WEP-2 | 60 | 200 | 5 | — | — | — | — | — | — | 110 | 40 |
| par- | | | | | | | | | | | | | | |
| ative | | | | | | | | | | | | | | |
| Exam- | | | | | | | | | | | | | | |
| ple 3 | | | | | | | | | | | | | | |
| Com- | SA1 | 10 | FNP0090 | 90 | 1500 | 8 | — | — | — | — | — | — | 128 | 27 |
| par- | | | | | | | | | | | | | | |
| ative | | | | | | | | | | | | | | |
| Exam- | | | | | | | | | | | | | | |
| ple 4 | | | | | | | | | | | | | | |
| Com- | SA1 | 3 | FNP0090 | 90 | 500 | 5 | — | — | — | — | — | — | 120 | 47 |
| par- | | | | | | | | | | | | | | |
| ative | | | | | | | | | | | | | | |
| Exam- | | | | | | | | | | | | | | |
| ple 5 | | | | | | | | | | | | | | |
| Com- | SA1 | 18 | FNP0090 | 90 | 500 | 5 | — | — | — | — | — | — | 120 | 28 |
| par- | | | | | | | | | | | | | | |
| ative | | | | | | | | | | | | | | |
| Exam- | | | | | | | | | | | | | | |
| ple 6 | | | | | | | | | | | | | | |

TABLE 2

| | | | | | | | | | Heat resistant | |
|---|---|---|---|---|---|---|---|---|---|---|
| | Sublimation transfer | | | | | | | | preservation stability | |
| | efficiency | | | | | | | | Remaining | |
| | Efficiency | | Concentration on fabric | | Fog on fabric | | Dry friction fastness | | amount | |
| | (%) | Evaluation | Concentration | Evaluation | B. G. | Evaluation | Grade | Evaluation | (%) | Evaluation |
| Example 1 | 51 | Excellent | 1.45 | Excellent | 0.8 | Good | 4.5 | Excellent | 5.0 | Good |
| Example 2 | 51 | Excellent | 1.46 | Excellent | 0.8 | Good | 5 | Excellent | 8.5 | Fair |
| Example 3 | 52 | Excellent | 1.47 | Excellent | 0.9 | Good | 3 | Fair | 8.7 | Fair |
| Example 4 | 42 | Fair | 1.32 | Good | 1.0 | Good | 4 | Good | 7.5 | Fair |
| Example 5 | 47 | Good | 1.37 | Good | 1.0 | Good | 4.5 | Excellent | 7.5 | Fair |
| Example 6 | 45 | Good | 1.37 | Good | 1.0 | Good | 3 | Fair | 6.5 | Good |
| Example 7 | 53 | Excellent | 1.20 | Fair | 0.5 | Excellent | 4.5 | Excellent | 4.7 | Good |
| Example 8 | 43 | Fair | 1.61 | Excellent | 1.3 | Fair | 4 | Good | 6.2 | Good |
| Example 9 | 52 | Excellent | 1.46 | Excellent | 0.7 | Good | 3.5 | Fair | 2.5 | Good |
| Example 10 | 48 | Good | 1.38 | Good | 0.8 | Good | 5 | Excellent | 9.2 | Fair |
| Example 11 | 51 | Excellent | 1.47 | Excellent | 0.6 | Good | 3 | Fair | 0.4 | Excellent |
| Example 12 | 44 | Fair | 1.30 | Good | 1.1 | Fair | 5 | Excellent | 11.5 | Fair |
| Example 13 | 54 | Excellent | 1.51 | Excellent | 0.5 | Excellent | 4.5 | Excellent | 5.1 | Good |
| Example 14 | 56 | Excellent | 1.53 | Excellent | 0.4 | Excellent | 4.5 | Excellent | 8.4 | Fair |
| Example 15 | 53 | Excellent | 1.48 | Excellent | 0.7 | Good | 4.5 | Excellent | 2.1 | Good |
| Example 16 | 53 | Excellent | 1.48 | Excellent | 0.5 | Excellent | 4 | Good | 0.3 | Excellent |
| Example 17 | 53 | Excellent | 1.48 | Excellent | 0.4 | Excellent | 3.5 | Fair | 0.2 | Excellent |
| Example 18 | 53 | Excellent | 1.47 | Excellent | 0.6 | Good | 4.5 | Excellent | 1.5 | Good |
| Example 19 | 52 | Excellent | 1.46 | Excellent | 0.7 | Good | 4.5 | Excellent | 3.5 | Good |
| Comparative | 35 | Poor | 1.05 | Poor | 0.4 | Excellent | 4.5 | Excellent | 4.5 | Good |
| Example 1 | | | | | | | | | | |
| Comparative | 51 | Excellent | 1.46 | Excellent | 0.9 | Good | 2 | Poor | 0.5 | Excellent |
| Example 2 | | | | | | | | | | |
| Comparative | 52 | Excellent | 1.48 | Excellent | 0.8 | Good | 4 | Good | 15.5 | Poor |
| Example 3 | | | | | | | | | | |
| Comparative | 39 | Poor | 1.27 | Fair | 1.3 | Fair | 4 | Good | 10.5 | Fair |
| Example 4 | | | | | | | | | | |
| Comparative | 55 | Excellent | 0.85 | Poor | 0.5 | Excellent | 4.5 | Excellent | 4.9 | Good |
| Example 5 | | | | | | | | | | |
| Comparative | 33 | Poor | 1.68 | Excellent | 2.0 | Poor | 3.5 | Fair | 6.9 | Good |
| Example 6 | | | | | | | | | | |

Tables 1 and 2 reveal the following.
(1) In the two component developers including the cyan toner of the present disclosure, the dye is dispersed in a good dispersion state, a dye aggregate having a large crystal diameter is less present in the toner, a dye crystalline body is prevented from dissociating from the toner, and migration of a dye crystal to fabric during sublimation transfer from transfer paper to the fabric can be suppressed (Examples 1 to 19).
(2) By virtue of increasing the addition amount of the mold release agent (wax), the toner components other than the dye is prevented from migrating to fabric during heat transfer to the fabric to improve fastness of the fabric, and when the addition amount exceeds a defined amount range, dispersibility of the mold release agent deteriorates to deteriorate heat resistance (Examples 9 to 12).
(3) When an ester wax other than hydrocarbon-based waxes is used as the mold release agent, compatibility with resin is high, and heat resistance deteriorates due to plasticization effect (Comparative Example 3).
(4) By virtue of adding the polymer-based dispersant, dispersibility of the dye is further improved, sublimation efficiency is enhanced, and concentration on fabric is improved (Examples 1, 13, and 14).
(5) By virtue of adding silica inside the toner during melting and kneading, kneading strength is enhanced, dispersibility of the dye and dispersibility of the mold release agent are improved, and sublimation efficiency and heat resistance characteristics are improved; and by virtue of using silica with a particle diameter within a defined range, these effects are further enhanced (Examples 1 and 15 to 19).

What is claimed is:

1. A cyan toner comprising toner particles including at least a binder resin, a sublimable dye, and a mold release agent, wherein
the binder resin includes a styrene-acrylic resin,
the sublimable dye includes C.I. Disperse Blue 56 at a ratio of 5% to 15% by mass in the toner particles,
the mold release agent has a melting point equal to or higher than 70° C. and equal to or lower than a softening point Tm of the cyan toner, and
transmittance at a wavelength of 430 nm measured using an ultraviolet-visible spectrophotometer is 30% or more.

2. The cyan toner according to claim 1, wherein
the mold release agent has a dispersion diameter of 200 to 1500 nm.

3. The cyan toner according to claim 1, wherein
the mold release agent is included in the toner particles at a ratio of 3% to 10% by mass.

4. The cyan toner according to claim 1, wherein
the mold release agent is a hydrocarbon-based wax selected from a polyolefin wax, a paraffin wax, and a Fischer-Tropsch wax.

5. The cyan toner according to claim 1, wherein
the toner particles further include a polymer-based dispersant.

6. The cyan toner according to claim 1, wherein
the toner particles further include silica particles.

7. The cyan toner according to claim 6, wherein
the silica particles are included in the toner particles at a ratio of 0.1% to 1.0% by mass.

8. The cyan toner according to claim 6, wherein
the silica particles have an average primary particle diameter of 7 to 60 nm.

9. A two component developer, comprising:
the cyan toner according to claim 1; and
a carrier.
